(19) United States
(12) Patent Application Publication
(10) Pub. No.: US 2019/0073651 A1
(43) Pub. Date: Mar. 7, 2019

(54) Method and System for Processing Lottery Transactions with Generic Retailer Gift Card Networks and Hardware

(71) Applicant: Scientific Games International, Inc., Newark, DE (US)

(72) Inventor: Aaron Michael Simms, Buford, GA (US)

(21) Appl. No.: 15/693,515

(22) Filed: Sep. 1, 2017

(51) Int. Cl. G06Q 20/20; G06Q 20/34; G06Q 20/10; G07F 17/32

(52) U.S. Cl. CPC G06Q 20/208; G06Q 20/34; G06Q 50/34; G07F 17/329; G07F 17/3244; G06Q 20/10

(57) ABSTRACT

A method and associated system are provided for implementing lottery ticket transactions via a player's mobile device and a retailer's existing gift card interchange system hosted by a gift card service provider without issuing an actual gift card. Purchase of the lottery ticket at the POS location mimics purchase of any other product using a gift card at the POS, which allows the retailer to conduct lottery transactions by piggybacking their existing gift card system provider's network.

### FIELD OF THE INVENTION

The present subject matter relates to methods and systems for distribution and sale of lottery and game type tickets, or other lottery transactions, using existing gift card infrastructures without the need for additional lottery or game specific hardware installed at a retailer's location.

### BACKGROUND

Lottery games have become a time-honored method of raising revenue for state and federal governments the world over. Traditional scratch-off and on-line games have evolved over decades, supplying increasing revenue year after year. However, after decades of growth, the sales curves associated with traditional games seem to be flattening out with the existing retailer base appearing to plateau. Consequently, both lotteries and their service providers are presently searching for new sales venues.

One of the most promising general new lottery retailers are “big box” retailers (e.g., Walmart, Target, etc.) and drug store retailers (e.g., Rite Aid, CVS, etc.). However, it attempts by lotteries and their service providers to partner with these retailers has been difficult, particularly because lottery products are considered by such retailers as too labor intensive and require special equipment. Additionally, aside from the added cost of the special equipment, its placement may require big box and drug store retailers to have a separate lottery sales/redemption location possibly requiring extra staff.

There have been attempts to resolve this barrier to sales in big box and drug stores with special in-lane hardware (US 2009/0163263), as well as special monitor interfaces configured with existing Point Of Sale (POS) systems (U.S. Pat. No. 6,899,621). However, these systems require the addition of special scanning or dispensing hardware at significant costs.

Recently, the popularity of prepaid gift and debit cards (referred to generically herein as “gift cards”) sold at big box and drug store retailers has resulted in the implementation of barcode reading activation systems tightly integrated with the stores' POS systems. This mass adoption of gift card activation systems allows for other products with barcodes and data conforming to the same specifications as the gift card items to be activated, tracked, or validated without the need to add any additional hardware at the retailer location. Additionally, since gift card activation systems are already integrated into the stores' POS systems, there is no need to have a separate location or additional staff to handle any additional products piggybacking on the gift card activation system.

Thus, the preponderance of existing gift card activation systems at big box and drug store POS systems creates the foundation for lottery and contest systems to utilize the existing card activation network to pass lottery/contest data between the retailer POS and a lottery central site. By complying with the format of the gift card activation system, lottery or contest data can be exchanged between the retailer's POS and a central hub allowing transactions (e.g. ticket sales and validation) to be conducted without any custom hardware.

Various methods and systems for using existing credit/debit card activation systems for logistical support of lottery transactions are set forth in U.S. Pat. No. 8,915,780; U.S. Pat. No. 9,558,622; and U.S. Pat. No. 9,721,425.

The present invention seeks to develop further logistical methods and systems to facilitate integration and implementation of lottery ticket transactions with a retailer's existing gift debit card exchange network.

### SUMMARY

Objects and advantages of the invention will be set forth in part in the following description, or may be obvious from the description, or may be learned through practice of the invention.

In accordance with aspects of the invention, a method is provided for implementing lottery transactions at a retail establishment by taking advantage of the retailer's existing gift card interchange system. In this manner, the retailer need not invest in lottery-specific terminals or other components, or employee additional personnel for lottery transactions. The lottery transactions may include the purchase of conventional draw game tickets (e.g. PowerBall™ tickets) that are authorized for sale in a given jurisdiction by a lottery authority. The type of retail establishment may vary widely within the scope and spirit of the invention. For example, in certain embodiments, the retail establishments may be convenience stores, gas stations, pubs, and any other establishment that typically sells lottery tickets to the public. The present methodology and related system have particular usefulness for much larger retail establishments, such as “big-box” retail stores that are part of a national or other geographic chain, wherein the sale of lottery ticket sales has generally not been implemented.

A “lottery jurisdiction” is understood to be a geographic area, such as a state, territory, or the like, governed by a governmental authority. A typical example of a lottery jurisdiction is an individual state-sponsored lottery, such as the Georgia (USA) or Connecticut (USA) state lotteries. A lottery jurisdiction may also encompass multiple states or territories that participate in a national-scale lottery game, such as the PowerBall™ and Mega Millions™ games in the United States.

A “lottery authority” is understood to be the governmental body, agency, or other organization that governs play of lottery games in a particular jurisdiction. For example, the Connecticut Lottery Corporation is the lottery authority for play of lottery games in Connecticut. A lottery authority may also be an organization that governs play of multi-state games (games across multiple jurisdictions). An example of such an organization is MUSL (Multi-State Lottery Association) in the United States that administers the PowerBall™ and Mega Millions™ games for its member states.

A “host lottery system” and “lottery service provider” are understood to be the system and associated entity that implement the logistical aspects of the lottery game for the lottery authority, such as printing and supplying tickets, providing server and computer services required to implement and manage the various games for the lottery authority, providing redemption services, and so forth. The host lottery system may be a system of the lottery authority, or may be maintained by the lottery service provider. An example of a host lottery system and associated lottery service provider are the systems and services provided by Scientific Games International, Inc., of Alpharetta, Ga., USA.

In one embodiment, the present invention provides a method for implementing lottery ticket transactions via a player's mobile device (e.g. a smart phone) and a retailer' existing gift card interchange system hosted by a gift card service provider. The method does not require issuance of an actual gift card or gift card account by the gift card service provider. With a processor, the gift card service provider generates a block of virtual gift card numbers, and transfers the block of virtual gift card numbers to a lottery service provider. The virtual gift card numbers are not linked to an issuer or similar entity in a closed-loop or open-loop credit or debit card network.

Via a mobile app downloaded to the player's mobile device, the player can initiate a lottery ticket transaction for subsequent completion at a retail location, the transaction including purchase of a lottery ticket and a purchase price. A unique code is generated by the mobile app or by the lottery service provider and transmitted to the mobile app, the code associated with the lottery ticket transaction. The unique code includes one of the virtual gift card numbers transmitted to the mobile app from the lottery service provider. With a processor, the lottery service provider associates and stores the virtual gift card number and lottery ticket transaction with a lottery account for the player.

At subsequent time of their choosing, the player presents the unique code on their mobile device to a retailer point of sale (POS) location to complete the lottery ticket transaction. The retailer scans the unique code presented by the mobile device into the gift card service provider's network. The processor at the gift card service provider recognizes the virtual gift card number in the unique code and passes the unique code through to the lottery service provider.

Upon receipt of the unique code, the lottery service provider processor activates the lottery ticket associated with the lottery ticket transaction and transmits a confirmation back to the gift card service provider that includes the purchase price of the lottery ticket transaction. The gift card service provider processor transmits a purchase confirmation back to the POS location that includes the purchase price to be collected by the retailer at the POS for the lottery ticket transaction, the purchase thereby mimicking a purchase of a gift card at the POS.

In a particular embodiment, the lottery ticket is a virtual draw game ticket that is generated by the mobile app and stored with the player account, the virtual ticket saved on the mobile device or subsequently retrieved by the mobile app from the lottery service provider processor.

The player's personal lottery account can be established by the player and the lottery service provider prior to or essentially at the same time as download of the mobile app to the player's mobile device.

The unique code generated and stored on the player's mobile device can take on any form that is readable by a scanner at the retail POS location and recognized by the gift card network. For example, the code may be a barcode compatible with the gift card provider's network.

The virtual gift card numbers may be deactivated in the gift card service provider's network upon being presented by the player at the POS location. If a previously deactivated number is later presented to a POS location, the gift card service provider processor may generate an alert message to the lottery service provider, and may also cancel the transaction at the POS location.

The player can pay for the lottery transaction at the POS location by any conventional means, such as with cash or via a credit/debit card. In a particular embodiment, if the player has virtual wallet in their lottery account, the purchase price can be deducted from funds available in the wallet, wherein the lottery service provider transfers the deducted funds to the gift card service provider or the retailer. For example, the lottery service provider may generate and transmit to the gift card provider a virtual coupon for the purchase price that is then accounted for in the lottery ticket transaction at the POS location, wherein the coupon is redeemable by the retailer to the lottery service provider.

In an alternate embodiment, the player may have a separate retailer-specific account, and payment for the lottery ticket purchase can be deducted from funds in the player's retailer-specific account. Funds from the player's lottery account may be transferrable to the player's retailer-specific account.

In a different scope, the present invention encompasses a method for a player to redeem funds from their personal lottery account for use at a retail location via a player's mobile device and the retailer' existing gift card interchange system hosted by a gift card service provider without issuing an actual gift card to the player. The funds in the player's lottery account may be accumulated winnings from lottery ticket game plays, or from any other source. With a processor, the gift card service provider generates a block of virtual gift card numbers, and transfers the block of virtual gift card numbers to a lottery service provider. The virtual gift card numbers are not linked to an issuer in a closed-loop or open-loop credit or debit card network.

Via a mobile app downloaded to the player's mobile device, the player can initiate a transaction wherein funds in their lottery account are designated for use at a retail location.

Via the mobile app, a unique code is generated and associated with the transaction, the unique code including one of the virtual gift card numbers transmitted to the mobile app from the lottery service provider. With a processor, the lottery service provider associates and stores the virtual gift card number and transaction amount with the player's lottery account.

At a time of their choosing, the player can present the unique code on their mobile device to a POS location at the retail location for purchase of goods or services, wherein the unique code is scanned into the gift card service provider's network. The gift card service provider processor recognizes the virtual gift card number in the unique code and passes the unique code through to the lottery service provider.

Upon receipt of the unique code, the lottery service provider processor verifies the transaction and transmits a confirmation back to the gift card service provider that includes the transaction fund amount requested by the player. The gift card service provider processor transmits a confirmation back to the POS location that includes the transaction fund amount associated with the unique code presented by the player.

The lottery service provider subsequently transfers the transaction fund amount from the player's lottery account to the gift card service provider or retailer.

As with the purchase transaction embodiment, the unique code may be a barcode compatible with the gift card service provider's network.

Also, as with the purchase transaction embodiment, the virtual gift card numbers may be deactivated in the gift card service provider's network upon being presented by the player at the POS location, and the gift card service provider processor may generate an alert message to the lottery service provider when the unique code presented by the player is deactivated, as well as cancel the transaction at the POS location.

The player may also have a separate retailer-specific account, and the transaction fund amount can be credited directly to the player's retailer-specific account at the POS location for subsequent use by the player at the retailer's various locations.

The present invention also encompasses various system embodiments incorporating the structure and operational principles set forth above and discussed in greater detail below.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the appended figures, in which:

FIG. 1 is a block diagram of a system and associated methodology in accordance with aspects of the present invention; and

FIG. 2 is a block diagram of an alternate system and associated methodology in accordance with aspects of the present invention.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

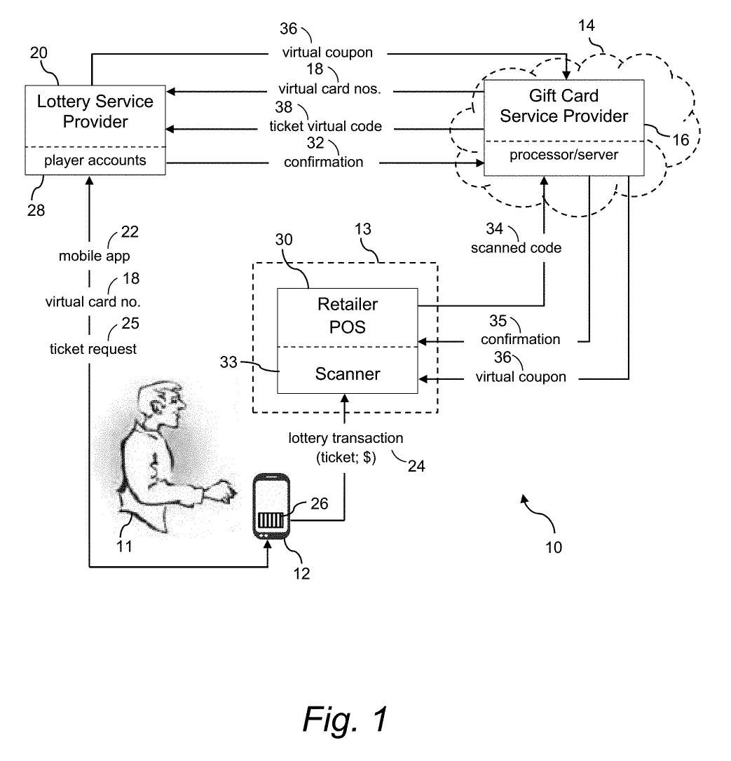

FIG. 1 depicts an embodiment of a method 10 and related system wherein a player/patron 11 at a retail establishment 13 initiates a lottery transaction 24 that includes a request for purchase of a lottery ticket at a purchase price. The retail establishment 13 is authorized for sale within a lottery jurisdiction by a lottery authority. As mentioned above, the type of retail establishment 13 may vary widely within the scope and spirit of the invention. A retail establishment or location 13, such as a retail store, convenience store, pub, restaurant, or the like, is generally authorized by the lottery authority 46 to carry out lottery activities within the respective jurisdiction, such as the sale of instant scratch-off tickets or terminal based tickets for draw games such as PowerBall™. As discussed above, the lottery jurisdiction may be a state and the lottery authority may be a governmental agency or entity, such as the Pennsylvania Lottery. A separate game provider may be partnered with the lottery jurisdiction to provide certain control, implementation, and logistical functions of the game. In this disclosure, the game provider is referred to as the lottery service provider 20 (the entity with a host system for implementing the lottery game). It should be appreciated that the type of retail establishment 13, lottery jurisdiction entities, and lottery service provider host system 20 are not limiting factors of the invention.

Although not limited to such, the present method 10 and related system have particular usefulness for larger retail establishments, such as “big-box” retail stores that are part of a national or other geographic chain. It should be appreciated that the invention encompasses a single retail establishment 13, as well as a multitude of affiliated establishments 13, as discussed in greater detail below.

The retail establishment 13 includes one or more retail point-of-sale (POS) locations or registers 30 wherein patrons 11 of the establishment 13 purchase goods or services. This POS location 30 may be considered as an entry point for the lottery ticket transaction request 24 from the patron (player) 11 into the retail establishment's POS system. Typically, a scanner 33 is associated with the POS register 30 to scan a UPC code on the purchased products, with the UPC code linked to a purchase price and identification of the products in a data file, as is well-known in the art.

The scanner 33 (or related peripheral scanner) is also conventionally used to scan/read codes (e.g. barcode, alpha-numeric code, data from a magnetic strip, etc.) on conventional gift cards presented by the patron 11 for the purchase of goods or services at the retail establishment 13.

A conventional gift card is essentially a substitute for currency (e.g. a gift certificate) in a form that automates the checkout and accounting processes. The gift cards typically have a barcode or magnetic strip that can be processed through a standard POS terminal or credit card machine at a retail location. The cards do not have value until they are “sold”, at which time the amount the customer wants to put on the card is entered and stored in the retailer's data base or in a gift card service provider's database and linked to the card. With a conventional closed-loop gift card interchange system 14 serviced by a gift card service provider 16, such as InComm™ (Atlanta, Ga.) or Blackhawk™ Network (Pleasanton, Calif.), a customer purchases a gift card from a retailer (which may be specifically for that particular retailer or another retailer) and a cashier enters the amount of the gift card into a POS terminal or a credit card terminal, and swipes the card for activation. The POS terminal or credit card terminal sends the command to the gift card service provider's server via the Internet to activate the card for the purchased amount. This amount is stored in a database at the server. If no problems are detected, the server sends a confirmation back to the POS terminal and the customer tenders payment for the gift card.

To redeem the gift card, the customer buys merchandise at the retail location affiliated with the card and presents the gift card as payment. The cashier selects the appropriate function at the POS terminal (or credit card terminal) and scans or swipes the card, wherein the card identification and purchase amount is transmitted to the gift card service provider 16 (specifically, to the provider's server). The server verifies the card, including the value of the card, and if no problems are detected, sends a confirmation back to the POS terminal that the transaction is approved for payment. The value of the gift card at the server's database is then reduced by the purchase amount.

Referring still to FIG. 1, the method 10 enables the lottery ticket transaction 24 in a manner that mimics a gift card redemption over the retailer's existing gift card services network 14. As discussed, the method 10 does not require issuance of an actual gift card or gift card account by the gift card service provider 16. With a processor or server, the gift card service provider 16 generates a virtual gift card numbers 18. These are numbers that are generated specifically for use with lottery transactions at the retailers that subscribe to the services of the gift card service provider 16. A block of these virtual gift card numbers 18 are transmitted to the lottery service provider 20 (e.g. to the host system of the lottery service provider). It should be appreciated that these virtual card numbers 18 are not otherwise linked to a financial institution, issuer, or processor in a traditional closed-loop or open-loop credit or debit card network.

The lottery service provider 20 provides a mobile app 22 (computer application) for download to a player's 11 conventional smart mobile device 12, such as a smart phone, computer tablet, PDA (personal data assistant), laptop computer, and the like. It should be appreciated that the term “mobile device” is used herein to encompass any manner of computer-enabled device that can operate the mobile app 22 and be carried by the player 11. At a time of their choosing, the player 11 uses the mobile app 22 to initiate the lottery ticket transaction 24 for subsequent completion at the retail location 30. The player interfaces with the lottery service provider 20 via the mobile app 22 and makes a lottery ticket request 25 for a specific purchase amount. The method 10 is not limited to any particular type of lottery ticket or game, but is well-suited for draw game tickets, such as PowerBall™ tickets, wherein the player also requests specific play numbers or randomly generated numbers that are stored with a record of the purchased ticket in a database at the lottery service provider 20. In other words, the lottery ticket can be a virtual drawn game ticket that is accessed by the player 11 via their mobile device 12 at a time of their choosing.

The method 10 includes generation of a unique code 26 that is associated with the lottery transaction 24 and displayed on the player's mobile device 12 via the mobile app 22. The unique code 26 can be generated directly by the mobile app 22 or by the lottery service provider and transmitted to the mobile app 22. The unique code 26 includes one of the virtual gift card numbers 18, which is transmitted to the mobile app 22 for inclusion in the unique code 26 if the code is generated by the mobile device 12, or included with the unique code 26 generated and transmitted by the lottery service provider 20 to the mobile app 22. The lottery service provider 20 associates and stores the virtual gift card number 18 and lottery ticket transaction 24 with a particular account 28 for the player 11.

The unique code 26 stored on the player's mobile device 12 can take on any form that is readable by the scanner 33 at the retail POS location 30 and compatible the gift card service provider's 16 operational network 14. For example, the code 26 may be a barcode as depicted in FIG. 1.e gift card provider's network.

At a subsequent time of their choosing, the player 11 presents the unique code 26 on their mobile device to a retailer point of sale (POS) location 30 to complete the lottery ticket transaction 24. The cashier at the retail location 30 scans the unique code 26 presented by the player's mobile device 12 via the scanner/reader 33. The scanned code 34 is then transmitted to processor at the gift card service provider 16 and entered into the gift card service provider's network 14. The processor at the gift card service provider 16 recognizes the virtual gift card number 18 in the unique code 26 and passes the individual virtual card number unique code through to the lottery service provider 20 via signal 38.

Upon receipt of the individual virtual ticket code 38, the lottery service provider 20 activates the lottery ticket specified by the player 11 and associated with the lottery ticket transaction 24 and transmits a confirmation 32 back to the gift card service provider 16 that includes the purchase price of the lottery ticket transaction 24.

The gift card service provider 16 then transmits a purchase confirmation 35 back to the POS location 30 that includes the purchase price to be collected by the retailer 13 at the POS location 30 for the lottery ticket transaction 24. Thus, from the retailer's side, the purchase of a lottery ticket at the POS location 30 mimics a purchase of any other product using a conventional gift card at the POS.

It should be understood that the actions and functions discussed above as taking place at the lottery service provider 20 or gift card service provider 16 are implemented by any manner of suitable processor or server system at the respective locations having the software and hardware architecture to carry out the stated functions.

As mentioned, the player 11 may be assigned a personal lottery account 28 maintained by the lottery service provider 20. This account 28 may provide the player 11 with a virtual wallet where funds from winning game plays are saved for later use or redemption by the player. The account 28 may be used to store the player's history of virtual lottery transactions 24, and so forth. The player's personal lottery account 28 can be established by the player 11 and the lottery service provider 20 prior to or essentially at the same time as download of the mobile app 22 to the player's mobile device 12.

The virtual gift card numbers 18 may be deactivated in the gift card service provider's network 14 upon being presented by the player 11 at the POS location 30. If a previously deactivated number 18 is later presented in a unique code 26 by a player 11, the gift card service provider 16 may generate an alert message to the lottery service provider 20 when the unique code presented by the player is deactivated, and may also cancel the transaction at the POS location.

Once the confirmation 35 is received back by the POS location 30, the player 11 can pay for the lottery transaction 24 at the POS location 30 by any conventional means, such as with cash or via a credit/debit card. In a particular embodiment wherein the player has a virtual wallet in their player account 28, as discussed above, the purchase price for the lottery transaction can be deducted from funds available in the wallet. The lottery service provider 20 will then transfer the deducted funds to the gift card service provider 16 or directly the retailer 13. For example, the lottery service provider 20 may generate and transmit to the gift card provider 16 a virtual coupon 36 for the purchase price, wherein this coupon 36 is redeemable by the retailer 13 to the lottery service provider 20 and thus accounted for in the lottery ticket transaction 24 at the POS location 30. In an alternate embodiment, the player 11 may have a separate retailer-specific account, and payment for the lottery ticket purchase 24 can be deducted from funds in the player's retailer-specific account. Funds from the player's lottery account 28 may be transferrable to the player's retailer-specific account.

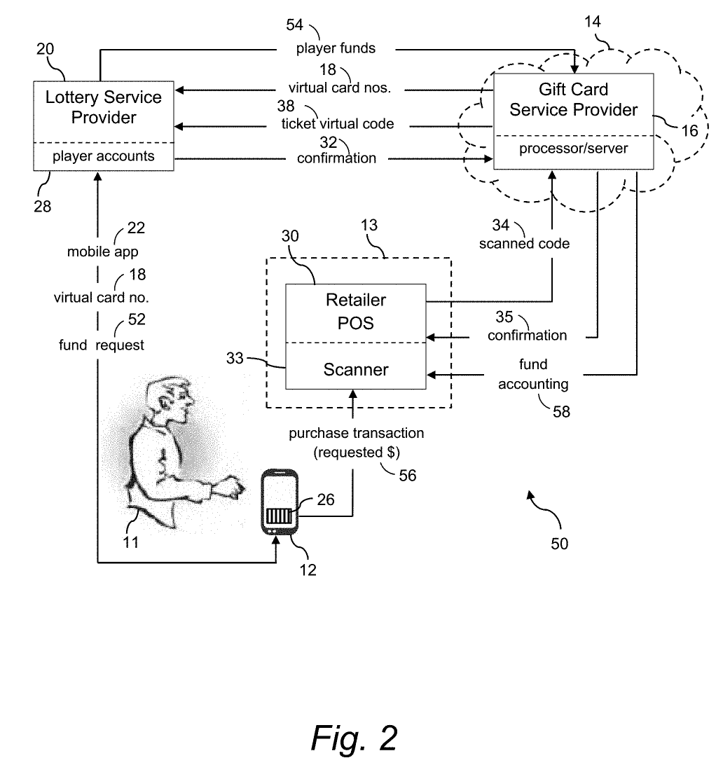

FIG. 2 depicts an alternative method 50 and related system for a player 11 to redeem funds from their personal lottery account 28 for use at a retail location 13 via the player's mobile device 12 and the retailer' existing gift card interchange system 14 hosted by the gift card service provider 16 without issuing an actual gift card to the player 11. The funds in the player's lottery account 28 may be accumulated winnings from lottery ticket game plays, or from any other source. As with the embodiment of FIG. 1, the gift card service provider 16 virtual gift card numbers 18, and transfers the block of these virtual gift card numbers 18 to the lottery service provider 20. Again, the virtual gift card numbers 18 are not otherwise linked to a financial institution, issuer, or processor in a traditional closed-loop or open-loop credit or debit card network.

Via the mobile app 22 downloaded to the player's mobile device 12, the player 11 can initiate a transaction 52 wherein funds in their lottery account 28 are designated for use at a retail location 13 for purchase of goods or services offered by the retailer.

The unique code 26 is generated as discussed above and is displayed on the player's mobile device 12 via the mobile app 22. The unique code 26 can be generated directly by the mobile app 22 or by the lottery service provider and transmitted to the mobile app 22. The unique code 26 includes one of the virtual gift card numbers 18, which is transmitted to the mobile app 22 for inclusion in the unique code 26 if the code is generated by the mobile device 12, or included with the unique code 26 generated and transmitted by the lottery service provider 20 to the mobile app 22. The lottery service provider 20 associates and stores the virtual gift card number 18 and fund transfer request 52 made by the player in the player's account 28.

At a time of their choosing, the player 11 can present the unique code 26 on their mobile device 12 to a POS location 30 at the retail location 13 for purchase of goods or services, wherein the unique code 26 is scanned into the gift card service provider's network 14, as discussed above. The gift card service provider 16 recognizes the virtual gift card number 18 in the unique code 26 and passes the number 18 through to the lottery service provider 20 via signal 38.

Upon receipt of the virtual gift card number 18, the lottery service provider 20 verifies the transaction and transmits a confirmation 32 back to the gift card service provider 16 that includes the transaction fund amount requested by the player 11 in the initial request 52. The gift card service provider 16 then transmits a confirmation 35 back to the POS location 30 that includes the transaction fund amount associated with the unique code 26 presented by the player 11 at the POS location 30, wherein the funds are credited against the purchase of goods or services at the retail location 13.

The lottery service provider 20 subsequently transfers the transaction fund amount 54 from the player's lottery 28 account to the gift card service provider 16 or directly to the retailer 13 via appropriate processing and accounting systems.

As with the purchase transaction embodiment 10 of FIG. 1, the unique code 26 may be a barcode compatible with the gift card service provider's network 14.

Also, as with the purchase transaction embodiment 10 of FIG. 1, the virtual gift card numbers 18 may be deactivated in the gift card service provider's network 14 upon being presented by the player at the POS location, and the gift card service provider 16 processor may generate an alert message to the lottery service provider 20 when a unique code 26 presented by a subsequent player 11 is the deactivated code, as well as cancel the transaction at the POS location 30.

The player 11 may also have a separate retailer-specific account, and the transaction fund amount can be credited directly to the player's retailer-specific account at the POS location 30 for subsequent use by the player at the retailer's various locations.

FIGS. 1 and 2 generically depict the gift card service provider 16, gift card network 14 and lottery service provider 20. As mentioned, these entities include systems that encompass any configuration of computer hardware and software to carry out the functionalities of the present methods 10, 50, as well as any manner of additional lottery functions known to those skilled in the art. It should be readily appreciated that such systems may include an integrated server, or any manner of periphery server or other hardware structure. The various entities and systems may be in communication for the reasons discussed above via a suitable secure communication network, which may include any manner of wide area network, wireless internet, or cloud computing. The systems may be a single networked computer, or a series of interconnected computers having access to the communications network via a gateway or other known networking system. The systems may include a memory for storing gaming procedures and routines, a microprocessor (MP) for executing the stored programs, a random access memory (RAM) and an input/output (I/O) bus. These devices may be multiplexed together via a common bus, or may each be directly connected via dedicated communications lines, depending on the needs of the system 10.

The various systems may be directly or indirectly connected through an I/O bus to any manner of peripheral devices such as storage devices, wireless adaptors, printers, and the like. In addition, a database (DB) may be communicatively connected to each system and provide a data repository for the storage and correlation of information gathered from the various processes discussed above.

It should be appreciated that embodiments of the methods 10, 50 and systems disclosed herein may be executed by one or more suitable networked components (e.g. multiple POS registers networked with a retailer's back office server), as well as networked components from a plurality of remote retail locations belonging to a particular retailer. Such gaming systems and computing devices may access one or more computer-readable media that embody computer-readable instructions which, when executed by at least one computer, cause the computer(s) to implement one or more embodiments of the methods of the present subject matter. Additionally or alternatively, the computing device(s) may comprise circuitry that renders the device(s) operative to implement one or more of the methods of the present subject matter. Furthermore, components of the presently-disclosed technology may be implemented using one or more computer-readable media.

As mentioned above, aspects of the present methods 10, 50 and related systems rely on the transmission of data over one or more communications networks. It should be appreciated that network communications can comprise sending and/or receiving information over one or more networks of various forms. For example, a network can comprise a dial-in network, a local area network (LAN), wide area network (WAN), public switched telephone network (PSTN), the Internet, an intranet or other type(s) of networks. A network may comprise any number and/or combination of hard-wired, wireless, or other communication links.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed is:

1. A method for implementing lottery ticket transactions via a player's mobile device and a retailer's existing gift card interchange system hosted by a gift card service provider without issuing an actual gift card, the method comprising:
with a processor, the gift card service provider generating a block of virtual gift card numbers, and transferring the block of virtual gift card numbers to a lottery service provider, the virtual gift card numbers not linked to an issuer in a closed-loop or open-loop credit or debit card network;
via a mobile app downloaded to the player's mobile device, providing for the player to initiate a lottery ticket transaction that includes purchase of a lottery ticket and a purchase price;
generating a unique code associated with the lottery ticket transaction for display by the mobile app on the player's mobile device, the unique code including one of the virtual gift card numbers transmitted to the mobile app from the lottery service provider;
with a processor, the lottery service provider associating and storing the virtual gift card number and lottery ticket transaction with a lottery account for the player;
enabling for the player to present the unique code on their mobile device to a retailer point of sale (POS) location for the lottery ticket transaction, wherein the retailer scans the unique code into the gift card service provider's network;
the gift card service provider processor recognizing the virtual gift card number in the unique code and passing the virtual gift card number through to the lottery service provider;
upon receipt of the virtual gift card number, the lottery service provider processor activating the lottery ticket associated with the lottery ticket transaction and transmitting a confirmation back to the gift card service provider that includes the purchase price of the lottery ticket transaction; and
the gift card service provider processor transmitting a purchase confirmation back to the POS location that includes the purchase price to be collected by the retailer at the POS for the lottery ticket transaction, wherein the purchase of the lottery ticket at the POS location mimics purchase of any other product using a gift card at the POS.

2. The method as in claim 1, wherein the lottery ticket is a virtual draw game ticket that is generated by the mobile app and stored with the player account, the virtual ticket saved on the mobile device or subsequently retrieved by the mobile app from the lottery service provider processor.

3. The method as in claim 1, wherein the player account is established by the player and the lottery service provider prior to or with download of the mobile app to the player's mobile device.

4. The method as in claim 1, wherein the unique code is a barcode compatible with the gift card provider's network.

5. The method as in claim 1, wherein the virtual gift card numbers are deactivated in the gift card service provider's network upon being presented by the player at the POS location, and when a previously deactivated virtual gift card number is presented at a POS location, the gift card service provider processor generating an alert message to the lottery service provider and cancelling the transaction at the POS location.

6. The method as in claim 1, wherein the purchase price is deducted from funds available to the player in their lottery account, wherein the lottery service provider transfers the deducted funds to the gift card service provider or the retailer.

7. The method as in claim 6, wherein the lottery service provider generates and transmits to the gift card provider a virtual coupon for the purchase price that is then accounted for in the lottery ticket transaction at the POS location, the coupon redeemable by the retailer to the lottery service provider.

8. The method as in claim 1, wherein the player has a separate retailer-specific account, and payment for the lottery ticket purchase is deducted from funds in the player's retailer-specific account.

9. The method as in claim 8, wherein funds from the player's lottery account are transferrable to the player's retailer-specific account.

10. A method for players to use funds from a personal lottery account at a retail location via a player's mobile device and a retailer's existing gift card interchange system hosted by a gift card service provider without issuing an actual gift card to the player, the method comprising:
with a processor, the gift card service provider generating a block of virtual gift card numbers, and transferring the block of virtual gift card numbers to a lottery service provider, the virtual gift card numbers not linked to an issuer in a closed-loop or open-loop credit or debit card network;
via a mobile app downloaded to the player's mobile device, providing for the player to initiate a transaction wherein funds in their lottery account are designated for use at a retail location;
via the mobile app, generating a unique code associated with the transaction, the unique code including one of the virtual gift card numbers transmitted to the mobile app from the lottery service provider;
with a processor, the lottery service provider associating and storing the virtual gift card number and transaction amount with the player's lottery account;
enabling for the player to present the unique code on their mobile device to a sale (POS) location at the retail location for purchase of goods or services, wherein the unique code is scanned into the gift card service provider's network;
the gift card service provider processor recognizing the virtual gift card number in the unique code and passing the unique code through to the lottery service provider;
upon receipt of the unique code, the lottery service provider processor verifying the transaction and transmitting a confirmation back to the gift card service provider that includes the transaction fund amount requested by the player;
the gift card service provider processor transmitting a confirmation back to the POS location that includes the transaction fund amount associated with the unique code presented by the player; and
the lottery service provider subsequently transferring the transaction fund amount from the player's lottery account to the gift card service provider or retailer.

11. The method as in claim 10, wherein the unique code is a barcode compatible with the gift card service provider's network.

12. The method as in claim 10, wherein the virtual gift card numbers are deactivated in the gift card service provider's network upon being presented by the player at the POS location, the gift card service provider processor generating an alert message to the lottery service provider when the unique code presented by the player is deactivated and cancelling the transaction at the POS location.

13. The method as in claim 10, wherein the player has a separate retailer-specific account, and the transaction fund amount is credited to the player's retailer-specific account.
